(19) United States
(12) Patent Application Publication
(10) Pub. No.: US 2002/0059088 A1
(43) Pub. Date: May 16, 2002

(54) Method and system for providing six sigma consulting services over a computer network

(76) Inventors: David Whalen, Mount Vernon, IN (US); William Calvin Baim III, Mount Vernon, IN (US); William Westbrook Bowen, Acworth, GA (US); Andrew Day, Beverly Hills, MI (US); William Herbert Dean, Allen, TX (US); Guillermo Gonzalez-Camacho, Farmington Hills, MI (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 09/682,299

(22) Filed: Aug. 16, 2001

Related U.S. Application Data
(60) Provisional application No. 60/225,662, filed on Aug. 16, 2000.

(51) Int. Cl. G06F 17/60

(52) U.S. Cl. 705/8

(57) ABSTRACT

A system and method is provided for delivering Six Sigma consulting services over a computer network. The system and method of the present invention operates to comprehensively provide on-line, individualized, real-time training and mentoring sessions using a variety of communication modes. Users of the system review an on-line training schedule and request on-line training sessions with Six Sigma consultants based upon available time slots. The request additionally includes a modifiable listing of session attendees and a description of the subject matter of focus of the session. The request is automatically forwarded to the attention of the requested consultant redundantly by several discrete electronic means so as to ensure that the requested consultant is notified and that the scheduled session is actually performed as scheduled. The inventive system, upon receipt of the request, automatically establishes the necessary voice, data, video, and text communications methods required to conduct the session using any and/or all of these methods. Upon reaching the appointed session time, the system automatically charges a customer account for time and resources and enables participants to enter the session in any suitable manner, either by phone in, or log in. Once the session is ended, the system charges the customer accordingly and the customer is enabled to utilize the other features of the system to maximize the benefits of the session.

### CROSS REFERENCE TO RELATED APPLICATIONS

This application claims the benefit of provisional patent application Ser. No. 60/225,662, filed Aug. 16, 2000, the disclosure of which is incorporated herein by reference.

### BACKGROUND OF THE INVENTION

The present invention relates generally to programs for training and mentoring employees in workforce effectiveness and defect reduction practices. More particularly, the present invention relates to a method and system for training and mentoring employees in the Six Sigma methodology of quality control processes. The method and system of the present invention enables individual trainers, consultants and students to efficiently and effectively interact remotely so as to increase the scope and content of the individual services offered to students.

It is conventionally understood in general business practices that certain levels of defects or efficiency problems are to be expected in the operation of the business. Striving to operate a business with 100% efficiency or absolutely zero defects, although admirable, most likely consumes more resources than it saves. In light of this fact, one goal of company managers is often to determine what level of defects are obtainable with the least possible costs and the greatest possible gains.

Over the years, many methodologies for error reduction and workforce effectiveness have been developed and utilized with varying degrees of success. Of these, arguably the most effective is the Six Sigma methodology initially developed in 1986 by Dr. Mikel J. Harry at Motorola, Inc. Statistically speaking, an organization's sigma (σ) level is a measurement that indicates the number of defects per every one million opportunities. Measuring sigma level, both for individual projects as well as overall, allows an organization to measure the quality and efficiency of its products and services. Most companies typically operate somewhere between three and four sigma, that is between 67,000 and 6,200 defects per million units. Conversely, an organization having a sigma level of Six Sigma (6 σ) generates only 3.4 defects per million opportunities. In essence, reaching an overall level of Six Sigma indicates the virtual elimination of defects from every product and process in the organization. By minimizing the number of defects or process inefficiencies, organizations can greatly increase their bottom line, thereby maximizing profits. Since its introduction, many organizations have adopted the Six Sigma methodology and have either achieved Six Sigma or are progressing toward Six Sigma.

In general, companies interested in adopting the Six Sigma approach must develop several different levels of Six Sigma professionals through intensive training and project application. The various levels of Six Sigma professional include: Green Belts, Black Belts, Master Black Belts, and Six Sigma Champions. A Green Belt is an individual who has been trained in the methodology and supports the adoption of the Six Sigma approach through participation as a team member. A Black Belt is a team leader experienced in the Six Sigma methodology. A Master Black Belt is an individual trained in the Six Sigma methodology who acts as the organization-wide Six Sigma program manager. This individual oversees the various Black Belt members and process improvement projects and provides guidance to Black Belts members as required. A final level of Six Sigma professional is the Six Sigma Champion who is generally a top executive or senior manager who provides the catalyst and driving force behind the organization's Six Sigma implementation. Each relevant member of the organization must be trained in the Six Sigma methodology, either by outside consultants hired to provide training and expertise, or by internal Master Black Belts. Please note that the titles associated with each level of Six Sigma professional are flexible in accordance with an organization's specific corporate culture. For example, rather than a Black Belt, some companies have adopted titles such as Six Sigma Project Leader, Process Owners and Process Quality Leaders. Similarly, Quality Director has been used to describe the role of a Master Black belt. Titles aside, the role of each professional is generally consistent across the various implementations.

A key element of the any workforce training process and, in particular, Six Sigma training, is a practical application of the concepts and tools to the student's workplace. This is accomplished by requiring each student to complete or, at a minimum, participate in the completion of a practical application project as part of the training in a just in time fashion. These projects often are aimed at reducing the defect level of some process within the student's actual business. Through this sort of real world project application, students apply the classroom lessons and enhance the value of the training over mere classroom instruction.

Conventionally, an organization, depending upon its size and financial circumstances, will conduct research and either hire a team of consultants to initially train its employees in the Six Sigma methodology or will have its employees participate in public seminars on the subject. If the latter path is taken, employees tend to miss out on the individual attention provided by on-site consultants. Further, although materials are generally provided, the level of feedback obtained, if any, is not sufficient to enable the employees to adequately absorb the material. An additional downside to the public seminar format for Six Sigma training is that the training is generally not formatted to the organization's particular business or project and further is not available on-demand or in accordance with the organization's schedule.

Conversely, hiring consultants to provide on-site training remedies several of these deficiencies, namely, scheduling concerns, training format and the lack of feedback and one-on-one attention. However, on-site training is generally a time-intensive and costly exercise, typically requiring that employees participate in several consecutive days of classroom-style training, while the consultants are available. Further, although initial feedback and attention is available, once the consultants leave the site, the employees often have no answers to follow up questions and no material review, often drastically reducing the progression to Six Sigma.

In addition, the project aspect of the training often flounders because the students misunderstand a tool or concept and, therefore, misapply it to their project following instructor departure. These mistakes are not corrected until subsequent on-site training sessions. By that time the project is significantly behind schedule and has an increased chance for failure.

Therefore, in order to maximize effectiveness, it is often necessary for the trainers to return to the site to provide inter-session assistance and feedback. The prohibitive cost of on-site training (generally on the order of $150,000 to $2,000,000) and possible return visits forecloses the possibility from all but the largest organizations. Further, even when the costs are not prohibitive, the on-site inter-session mentoring consultants have difficulty servicing a client that has multiple remotely located sites. The on-site assistance is only available when the consultant is at the particular site in question.

Since the advent of the Internet, several providers of Six Sigma consulting and training services have developed Internet web pages devoted to various products and services incorporating each of the above described training methods. For example, Six Sigma Academy (http://www.6-sigma.com, viewed Aug. 4, 2000), provides a web site including a detailed description of their consulting services, historical information, as well as an on-line listing of books and videos available for purchase. Similarly, Six Sigma Partnering (http://www.sixsigmapartner.com, viewed Aug. 4, 2000) provides a web site including service and seminar descriptions, research and background information, and distance learning materials which enable clients to study on their own and email materials back to Six Sigma Partnering for review and evaluation.

Each of the Internet web sites described above simply promote a Six Sigma training approach failing into one of the above-described categories, each with its inherent deficiencies and problems. By offering contact and descriptive information concerning on-site training, the web sites are simply an Internet advertisement for such services. Similarly, offerings of books, videos, or home-study courses are analogous to public seminars in that feedback and course format are not amenable to rapid implementation of the Six Sigma methodology. Furthermore, these sites do not address the need for inter-session project assistance as described above.

Therefore, there is a need in the art of Six Sigma training and consulting services to provide low cost and effective means for adopting the Six Sigma methodology regardless of organization size and financial position. There is further a need for a Six Sigma training system that provides the benefits of both the on-site training approach and the public seminar or home-study approach. There is also a need for a system which enables Six Sigma consultants to accurately and efficiently manage multiple training sessions while maximizing the effectiveness to customers. Further, there is an additional need for a system which enables Six Sigma consultants provide inter-session project assistance regardless of the initial raining mode or process.

### BRIEF SUMMARY OF THE INVENTION

The present invention overcomes the problems noted above, and provides additional advantages, by providing for a method and system for delivering Six Sigma consulting services over a computer network. The system of the present invention operates to comprehensively provide on-line, individualized, real-time training sessions using a variety of communication modes. The system of the present invention also provides research materials, downloadable training aids and tests, topical communication forums, and on-line project reviews that together provide customers with the most efficient, cost-effective method for adopting the Six Sigma methodology.

Customers of the system review an on-line training schedule and request on-line training sessions with Six Sigma consultants based upon available time slots. The request additionally includes a modifiable listing of session attendees and a description of the subject matter of focus of the session. The request is automatically forwarded to the attention of the requested consultant redundantly by several discrete electronic means so as to ensure that the requested consultant is notified and that the scheduled session is actually performed as scheduled. Requests may be placed as late as twenty four hours before the scheduled time, depending on availability, thereby better meeting the time demands of the customer.

The inventive system, upon receipt of the request, automatically establishes the necessary voice, data, video, and text communications methods required to conduct the session using any and/or all of these methods. Suitable methods may include live webcasts (i.e., streaming audio/video over the Internet), data downloads, conference calls, document sharing software and Internet instant messaging.

Upon reaching the appointed session time, the system automatically charges a customer account for time and resources and enables participants to enter the session in any suitable manner, either by phone in, or log in. During the session, information may be passed to session participants in a variety of discrete means (e.g., voice, data, text, etc.), either individually, in sub-groups, or to the entire group. Once the session is ended, the system charges the customer accordingly and the customer is enabled to utilize the other features of the system to maximize the benefits of the session.

### BRIEF DESCRIPTION OF THE DRAWINGS

The present invention can be understood more completely by reading the following Detailed Description of exemplary embodiments, in conjunction with the accompanying drawings, in which:

FIG. 1 is a block diagram of a computer network suitable for implementing a method and system according to the present invention;

FIG. 2 is a high level organizational map 200 illustrating one embodiment of a web site incorporating the system of the present invention;

FIG. 3 is a second level organizational map illustrating the various options and web pages available under the Six Sigma information page shown in FIG. 2;

FIG. 4 is a second level organizational map illustrating the various options and web pages available under the on-site consulting services page shown in FIG. 2;

FIG. 5 is a second level organizational map illustrating the various options and web pages available under the registration/subscription page shown in FIG. 2;

FIG. 6 is a second level organizational map illustrating the various options and web pages available under the log-in page shown in FIG. 2;

FIG. 7 is a second level organizational map illustrating the various options and web pages available under the Six Sigma forum page shown in FIG. 2;

FIG. 8 is a second level organizational map illustrating the various options and web pages available under the mentoring/project review page shown in FIG. 2;

FIG. 9 is a second level organizational map illustrating the various options and web pages available under the training and BB/GB certifications page shown in FIG. 2;

FIG. 10 is a second level organizational map illustrating the various options and web pages available under the benchmarking/database services page shown in FIG. 2;

FIG. 11 is a second level organizational map illustrating the various options and web pages available under the statistical reports/journal page shown in FIG. 2;

FIG. 12 is a second level organizational map illustrating the various options and web pages available under the statistical tools download page shown in FIG. 2;

FIG. 13 is a second level organizational map illustrating the various options and web pages available under the readiness diagnostic test page shown in FIG. 2;

FIG. 14 is a second level organizational map illustrating the various options and web pages available under the Six Sigma shopping page shown in FIG. 2; and

FIG. 15 is a flow chart describing a method for conducting a mentoring/project review session in accordance with the present invention.

### DETAILED DESCRIPTION OF THE INVENTION

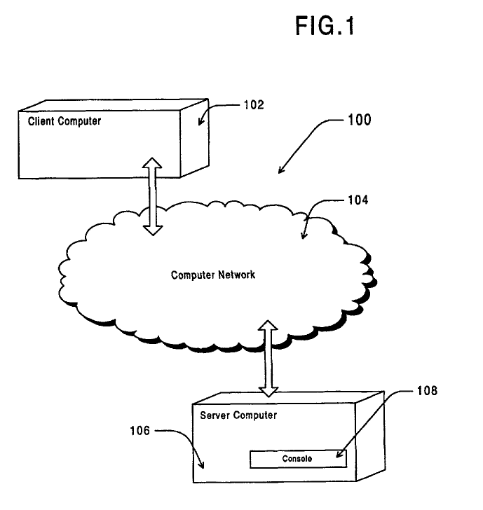

An Internet computer system 100 is generally illustrated in FIG. 1. A conventional client computer system 102, executing a client browser application that supports the HTTP protocol, is connected typically through an Internet Service Provider (ISP) to the Internet 104 or other suitable computer network. A server computer system 106 is also coupled typically through an Internet Service Provider to the Internet 104. The server computer system 106, controlled by a local console 108, executes at least one web server application conventionally known as a HTTPd server. In addition, the server computer system 106 preferably provides local storage for at least one, though typically many, web pages. Also, server computer system 106 may include several individual server computers at various locations on the network.

The client computer system requests a web page by issuing a URL request through the Internet 104 to the server system 106. A URL consistent with the present invention may be a simple URL of the form:

<protocol_identifier>://<server_path>/<web_page_path>

A protocol_identifier of http specifies the conventional hyper-text transfer protocol. A URL request for a secure Internet communication session typically utilizes the secure protocol identifier https, assuming that the client browser and web server each support and implement the secure sockets layer (SSL). The server_path is typically of the form prefix.domain, where the prefix is typically www to designate a web server and the domain is the standard Internet sub-domain.top-level-domain of the server system 106. The optional web_page_path is provided to specifically identify a particular hyper-text page maintained by the web server.

In response to a received URL identifying an existing web page, the server system 106 returns the web page, subject to the HTTP protocol, to the client computer system 102. This web page typically incorporates both textural and graphical information including embedded hyper-text links, commonly referred to as hyperlinks, that permit the client user to readily select a next URL for issuance to the Internet 104.

The URL issued from the client system 102 may also be of a complex form that identifies a common gateway interface (CGI) program on a server system 106. Such a HTML hyperlink reference is typically of the form:

<form action=http://www.vendor.com/cgi-bin/logon.cgi method=post>

A hyper-text link of this form directs the execution of the logon.cgi program on an HTTP server in response to a client-side selection of the hyperlink. A logon form supported by a logon CGI program is typically used to obtain a client user login name and password to initiate an authenticated session between the client browser and web server for purposes of supporting, for example, a secure purchase transaction or a secure communications session.

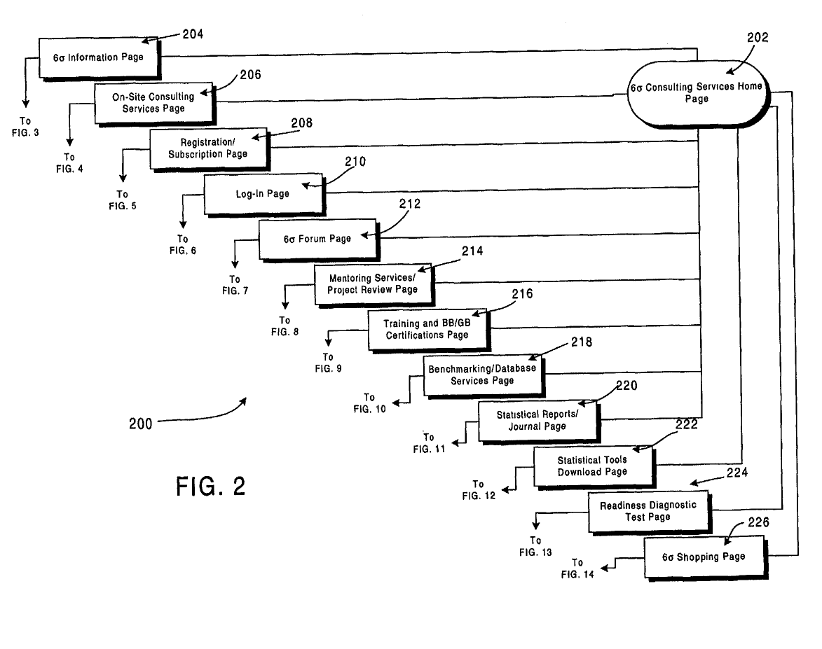

Referring now to FIG. 2, there is shown a high level organizational map 200 illustrating one embodiment of a web site incorporating the system of the present invention. The web site is preferably hosted on at least one server computer in server system 106, described above. A web site is a collection of interconnected web pages hosted on the same or different servers for providing a variety of material typically sharing a common subject matter. Upon receipt of a particular URL from a client computer, the server system returns a Six Sigma Consulting Services home page 202 presenting various elements including both informational content as well as a plurality of system options, each selectable by an associated hyperlink. Preferable informational content includes general Six Sigma information, news headlines, and stock ticker information (for subscription members). Through conventional processes, each available hyperlink electronically connects the home page 202 to a plurality of web pages, each displaying different content. The various web pages preferably include: a Six Sigma information page 204; an on-site consulting services page 206; a registration/subscription page 208; a log-in page 210; a Six Sigma forum page 212; a mentoring services page 214; a training and Black Belt/Green Belt certifications page 216; a benchmarking/database services page 218; a statistical reports/journal page 220; a statistical tools download page 222; a readiness diagnostic page 224; and a Six Sigma shopping page 228. Each of the web pages 204-228 and the functionalities they offer will be described in additional detail below.

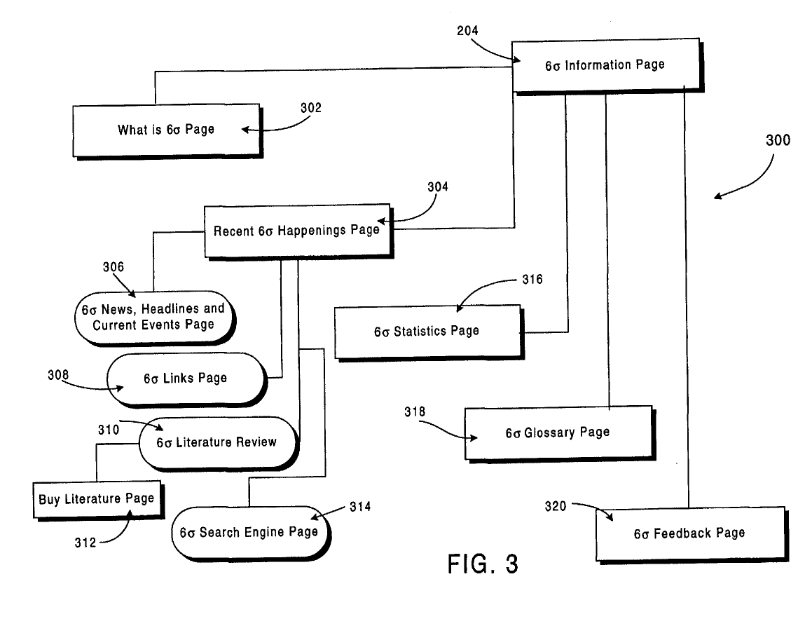

The Six Sigma information page 204 and those pages available thereunder are provided for describing to site visitors the nature and background behind the Six Sigma methodology. Turning to FIG. 3, there can be see a second level organizational map 300 illustrating the various options and web pages available under the Six Sigma information page 204. In order to provide site visitors with a brief overview of the history and rationale behind Six Sigma, a what is Six Sigma? page 302 is provided. Further, a recent Six Sigma happenings page 304 is provided for informing visitors as to news, relevant Internet sites; and literature reviews on pages 306, 308, and 310, respectively. In addition, visitors are offered the opportunity to purchase review literature on-line on the buy literature page 312. Also, a search engine page 314 is provided for enabling site visitors to conduct a key word search for Six Sigma materials. Pages 316 and 318 provide statistical information regarding Six Sigma implementation, and Six Sigma terminology, respectively. Also, a feedback page 320 is provided for enabling site to respond to site operators and let them know what additional materials and services should be included or removed from the site.

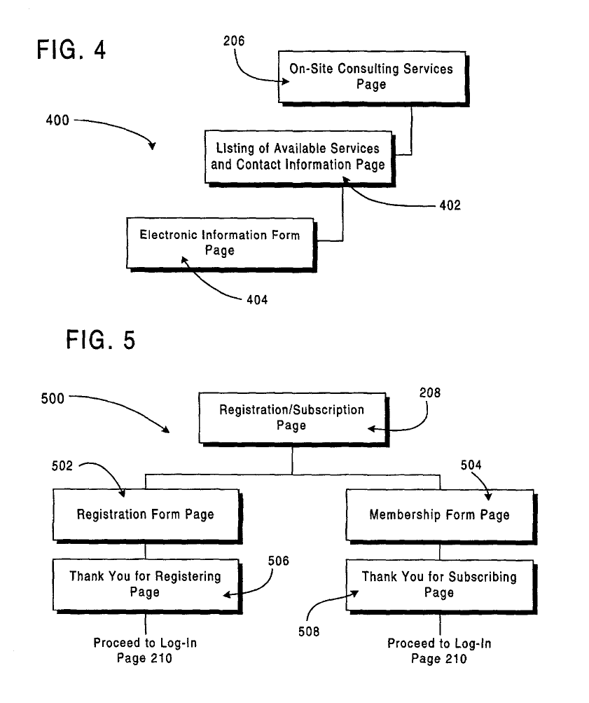

The on-site consulting services page 206 generally provides information relating to traditional consulting services offered by the site owners. As described above, these services generally entail scheduling an on-site training session for educating and implementing the Six Sigma methodology and additionally on site inter-session project mentors to ensure learning success. Referring to FIG. 4, there is shown a second level organizational map 400 of options available under the on-site consulting services page 206. A service listing and contact information page 402 is provided for detailing the on-site services and an electronic information form page 404 is provided for enabling site visitors to electronically request information on any of the listed services.

In a preferred embodiment, the system of the present invention provides for the dissemination of information at several levels. An initial, informative level enables casual or researching site visitors to view some of the content of the web site. A second, registration level offers additional information and functionality to users who register with the site. A third, subscription level increases the functionality of the site to users who subscribe to several on-line services offered by the site. Preferably, the informative level and the registered user level are available at no cost to users, while the subscription level requires payment, either as the services are used, or as part of a monthly service agreement.

In accordance with this embodiment, the registration/subscription page 208 is provided for enabling users to register with the site or subscribe to site services. Referring now to FIG. 5, there is shown a second level organizational map 500 illustrating the various options and web pages available under the registration/subscription page 208. In particular, upon reaching the registration/subscription page 208, the user is presented with the options and advantages available with each level of access. At this point the user may select to either register or subscribe to member services. Respective registration forms are provided on pages 502 and 504. Once the user has properly submitted all required information and the user has selected appropriate log-in information (typically a unique username and password combination), the user is thanked at pages 506 and 508 and presented with the log-in page 210. As is understood in the art, the registration information is saved and associated with the particular username and password combination, thereby enabling the system to identify users based their username and password and to provide appropriate levels of access. In another embodiment, the user, upon registering, is e-mailed appropriate account name and password information. This embodiment ensures that the user's contact information has been entered correctly.

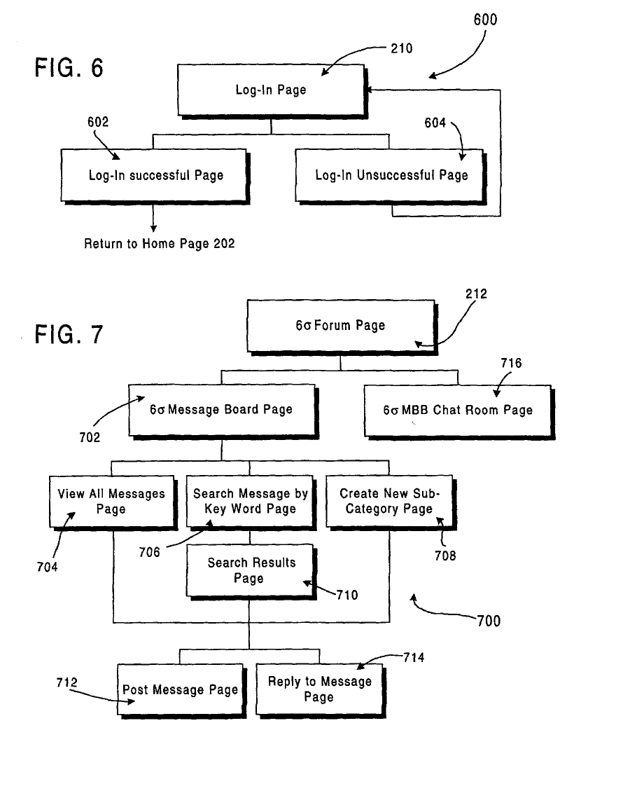

The log-in page 210 simply receives the users log-in information, either from those users who just registered at page 108 or for return users. Referring to FIG. 6, there is shown a second level organizational map 600 illustrating the options and web pages available under the log-in page 210. Upon receipt of log-in information from the user, the site presents either a log-in successful page 602 or a log-in unsuccessful page 604 depending upon whether the information supplied was recognized and active. If the log-in was unsuccessful, the user may return to the log-in page 210 to re-enter the log-in information. If the log-in was successful, the user is then returned to the home page with access various additional site areas. It should be understood that, if a user attempts to view information reserved for either registered or subscription members without first logging in as such a user, an error screen will be displayed indicated the lack of access and further enabling the user to either enter log-in information or register for access with the site. Alternatively, selection of these features simply triggers the display of the registration/subscription page 208.

The Six Sigma forum page 212 is available to registered users and enables them to review and post messages pertaining to the Six Sigma methodology. Referring now the FIG. 7, there is shown a second level organizational map 700 illustrating the options and web pages available under the Six Sigma forum page 212. Preferably, page 212 simply provides a general description of the available forum services viewable to all visitors. However, selection of any of the pages associated with the forum would require registration and log-in. The Six Sigma forum page 212 provides registered users with two discrete forms of communication. A first, the Six Sigma message board, is similar to most conventional message boards in that in enables users to view, reply to, and post new messages on the board for others to see and respond to. Preferably, Six Sigma discussion topics are separated by categories associated with various components of the methodology such as Define, Measure, Analyze, Improve, Control, etc., so as to create consistent discussion threads useful to the users. A Six Sigma message board page 702 is provided outlining the procedures and capabilities of the message board. Under the message board page 702, users may select to view the recent postings on page 704, search the message board by key word on page 706, or create a new message board category and insert a new message on page 708. Search results are provided on page 710. In response to any messages reviewed, the user may post a message to the board on page 712 and/or reply to a message on page 714. The second discrete method of communicating with other users regarding Six Sigma is through the Six Sigma chat room. By selecting a chat room page 716, users are inserted into a chat room where the Six Sigma methodology is the general topic of conversation. In a preferred embodiment, the chat rooms may be scheduled for specific guest visitors or reserved for specific Six Sigma sub-topics.

In accordance with the present invention, Six Sigma consultants monitor the message board and chat room to ensure that only accurate information is disseminated. Further, upon receipt of new postings to the message board, Six Sigma consultants are immediately notified of their presence and respond to the request within a short period of time. This feature enables users to receive answers to specific questions without incurring the cost of establishing a mentoring session in the manner set forth below.

As suggested above, there is a significant need in the area of Six Sigma consulting services to be able to effectively train individuals in the Six Sigma methodology without incurring the substantial costs associated with on-site training. However, in those circumstances where on-site training has occurred, there remains a need for the trainers to be accessible to the students once they leave the site, in order to answer follow-up questions, refresh information taught, and help with real-world project applications and project review. In order to meet these needs the system of the present invention provides an on-line mentoring/project review service designed to enable students to interact remotely with trainers in a mentoring relationship. Preferably, this option is available solely to subscription members and requires a suitable log-in.

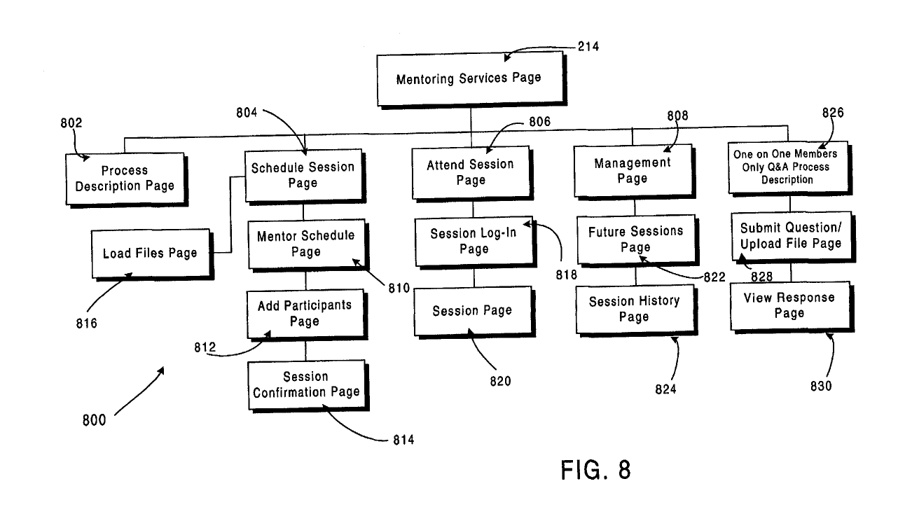

Referring to FIG. 8, there is shown a second level organizational map 800 illustrating the various options and web pages available under the mentoring/project review services page 214. In particular, once a user has selected the mentoring services option and has been presented with the mentoring services page 214, the user is presented with the option to review the mentoring process on page 802, schedule a mentoring session beginning on page 804, attend a previously scheduled mentoring session beginning on page 806 and reviewing management information on page 808. If a user elects to schedule a mentoring session, the user is provided with a listing of the mentors having expertise in either a particular area or with a particular client. Selection of a schedule page 810 displays a session schedule for a selected mentor. Preferably, sessions are blocked in 1/2 hour increments and may be scheduled up to 24 hours prior to the session time. The users then selects an available session time and submits a request for a session.

On page 812, the user can add participants to the session. Once the session has been confirmed by the site, the user is provided with a session confirmation on page 814. At the time of session scheduling, the system of the present invention automatically allocates sufficient resources to the session in the form of web addresses, conference call telephone lines and access numbers. Preferably, this may be accomplished by the system accessing the particular individual scheduling systems or by merely having dedicated resources assigned to each consultant thereby eliminating the need to interface with multiple systems. In this manner, session attendees, either consultants or students have a reduced burden in participating in the session. Further, electronic messages are preferably delivered to session participants by the system to remind participants of the upcoming session. These may include electronic mail message, pager notification, and voice mail notifications. In many instances, it will be advantageous for users to provide data to the trainers for review prior to the session. These materials may be uploaded to the site on page 816.

Once a session has been scheduled, users may attend a session beginning on page 806. On page 818, the user enters the session log-in information provided on confirmation page 814. Provided that the log-in information is properly entered, the user then accesses a session page 820 previously established by the system to host the particular session. Various session formats are envisioned as a part of the present invention. In one embodiment, a session may include several discrete means of communication utilizing separate communications technologies. For example, the session page 820 may include a live streaming audio or video feed from the trainer as well as a chat or instant messaging interface for enabling the user to interact with the trainer on a real-time basis. If the user has the capability to interact via voice or video over the Internet, this medium may be utilized for conferencing. For those users lacking enhanced technology, the majority of communication may take place via a conference telephone call, with examples and additional materials being transferred to the user over the Internet as needed.

Several examples of on-line collaboration applications are suitable for providing connectivity between the various session participants in real-time over the Internet. One example of such an application is MeetingPlace by Latitude Communications Inc. The MeetingPlace application enables users to utilize various means of communication from web browsers to cellular telephones to interact with each other in a common forum. A second such application offering similar functionality is PlaceWare by PlaceWare, Inc.

By selecting the management page 808, management level users can review all mentoring/project review activity for their employees, either by viewing a listing of future scheduled session on page 822 or by reviewing a session history page 824 including the details of all past session.

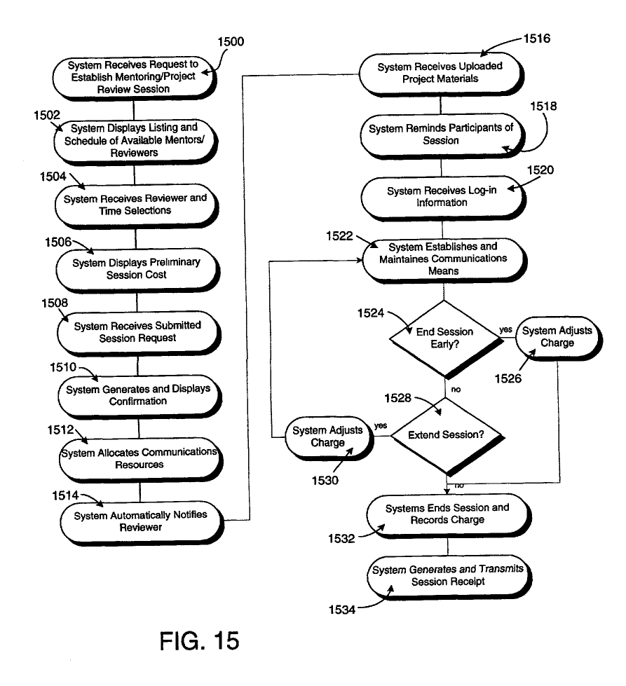

Referring now to FIG. 15 there is shown a flow chart describing a method for conducting a mentoring/project review session in accordance with the present invention. In step 1500, the system receives a request, over the computer network, to establish a mentoring/project review session. In step 1502, the system displays a listing of available mentors/reviewers and a schedule of their available session times. In step 1504, the system receives a selected reviewer and session time from the user. In step 1506, the system displays a preliminary session cost based upon the selected time and the selected reviewer. In step 1508, the system receives a submitted session request. In step 1510, the system generates a session confirmation including session log-in information and displays the confirmation to the user.

Once the session has been established, the system, in step 1512, allocates resources to the session in the form of web space, and telephone resources. Further, in step 1514, the system automatically notifies the selected mentor/reviewer of the confirmed session time. Preferably this includes redundant notification by such means as electronic mail, voice mail, and paging. In step 1516, the system receives project materials from the user for review during the session. These materials may be in many conventional forms such as spreadsheets, powerpoint presentations, etc. and serve to assist the reviewer in reviewing the particular project with the user.

24 hours prior to session commencement, the system, in step 1518, sends electronic mail messages to each session participant reminding them of the forthcoming session time and log-in information. Upon session time commencement, the system, in step 1520, receives log-in information from each of the participants. In step 1522, the system establishes and maintains the necessary communications means for the duration of the session. In step 1524, the system enables the user to end the session early. If the user ends the session early, the system, in step 1526 may adjust the charge for the session (based upon system policy). However, if the user elects to not end the session early, the communications means are maintained.

Upon the near expiration of the pre-scheduled session time, the system, in step 1528, notifies the user of the impending session end and inquires as to an extension of the session. If an extension is requested, the system, in step 1530 adjusts the charge for the session and maintains the communication means, returning to step 1522. If, however, an extension is not requested, the system, in step 1532, ends the session and records the final charge. In step 1534, the system electronically transmits a session receipt to the user indicating the charge and terms for payment.

Referring back to FIG. 8, there is shown an additional feature available under the mentoring/project review services page 214. A members only one on one question and answer service page 826 is provided for instructing users on the operation of the feature. By selecting page 828, users are able to submit questions to Six Sigma consultants and/or upload data files or the like for individual review. Upon user submission of a question and/or data files, a consultant reviews the question and/or analyzes the data set to provide answers and advice based on the findings and results of the analysis. This service can be used as additional support to the user by enabling the user to follow up on a previous mentoring session with single questions not requiring a full on-line session or conference call. The text and data transmissions from both the user and the consultant are preferably uploaded to the web-site and shared through conventional means. Access to this information would be secured only to the user and consultant involved by the password account protections set forth in detail above. In this manner, a user submits an inquiry to the site, the consultant receives the inquiry from the site, and the consultant then posts an answer or analysis to the site for retrieval and review by the user. Such an information sharing mechanism facilitates service accounting and also provides for an archive of answered questions to be used by the consultants in response to future inquiries.

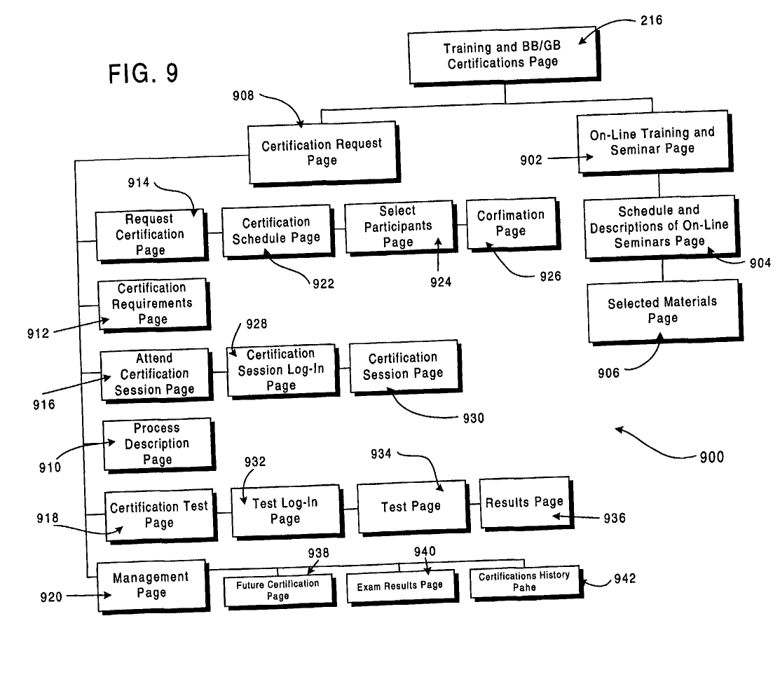

In addition to post-training mentoring/project review services, there is also a need in the Six Sigma training industry for additional types of training and consulting services provided from a remote location. Two additional examples of services provided by the system of the present invention are available from the training and BB/GB certifications page 216. Referring now to FIG. 9, there is shown a second level organizational map of the options and web pages available under the training and BB/GB certifications page 216. In a preferred embodiment, the training option available on page 216 refers to pre-established training materials and prescheduled on-line seminars available for review and attendance. By selecting a on-line training and seminar page 902, users are provided with a general description of the services and material available on the site. By selecting a schedule and descriptions of on-line seminars 904, a listing of available training materials and a schedule of on-line seminars is presented to the user. The user may then select particular materials to view or seminars to attend and view them on corresponding page 906.

By choosing to view a certification request page 908, a user can request and/or attend a certification session comprising two distinct portions. In a first portion, a certification exam is administered and its results indicate a in depth knowledge of the materials necessary for certification as either a black belt or a green belt. In a second portion, the user participates in a review of various project examples before a review committee. The user is presented with the option to review the certification process on page 910, review the requirements for certification on page 912, request certification beginning on page 914, attend a previously scheduled certification session (either as the individual up for certification or as part of the review committee) beginning on page 916, take a certification exam beginning on page 918, and review management information on page 920. If a user elects to schedule a mentoring session, the user is provided with a schedule of the certification sessions on page 922. Preferably, as above, sessions may be scheduled up to 24 hours prior to the session time and entail the review of project examples utilizing the Six Sigma methodology. The users the selects an available session time and submits a request for a session. Once the certification session has been confirmed by the site, the user is provided with a session confirmation on page 924. On page 926, a user can add participants for admission to the session as part of the review committee, so that they may actively monitor the project review process.

Once a certification session has been scheduled, admitted users may attend a session beginning on page 916. On page 928, the user enters the session log-in information provided on confirmation page 924. Provided that the log-in information is properly entered, the user then accesses a session page 930 previously established by the system to host the particular session. Various suitable session formats are envisioned as a part of the present invention, as set forth above.

The individual(s) being certified initially accesses the certification exam page 918. The user then logs-in on page 932 and, on page 934, is presented with the certification exam. Because the exam is administered electronically, results for the exam are generated automatically upon submission and the user is notified immediately on page 936 whether the certification exam has been passed. If the exam is passed, the user may log-in to the session (at the scheduled time) on page 916 as set forth above.

On page 920, a management level user is provided several management options: viewing future scheduled certification session on page 938, reviewing prior test results on page 940, and reviewing the details of prior certification sessions either attended on page 942. By providing remote administration of certification examinations, a substantial cost savings to the organization is realized. Further, by certifying individuals at their own pace, students can learn without the increased pressure of predetermined time deadlines.

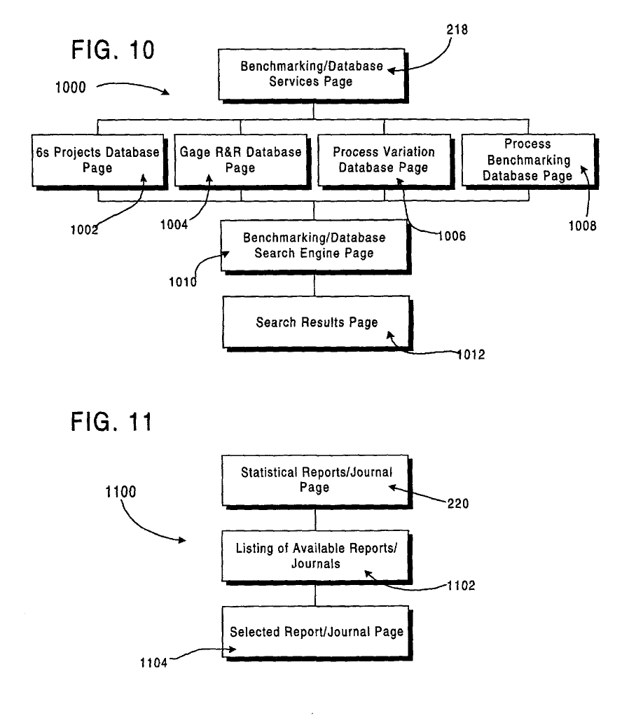

In order to determine the best coarse of action for a particular project, it is often desirable for organizations to review project reports covering projects similar in nature to their own projects. In order to provide such research tools, the system of the present invention provides a plurality of project and reference databases under the benchmark/database services page 218. Referring now to FIG. 10, there is shown a second level organizational chart 1000 illustrating the options and web pages available under the benchmarking/database services page 218. In particular, users may select from a plurality of references including: a Six Sigma project database on page 1002, including a collection of prior projects showing the major work flow, the tools used to solve the project, and the types of benefits obtained; a gage error database on page 1004, listing various measuring methods and their associated measurement error; a process variation database on page 1006, including a list of common tasks and the errors associated therewith; and a process benchmarking database on page 1008, listing overall business and manufacturing processes and the efficiency and effectiveness thereof. Users may search through selected databases by using the search engine on page 1010 and review the results on page 1012. In this way, site visitors are able to feed off of the work of others without the need to reinvent the wheel for every process.

An additional feature of the system of the present invention is the provision of statistical reports and journals in an on-line or downloadable format. Referring now to FIG. 11, there is shown a second level operational map 1100, illustrating the various options and web pages available under the statistical reports/journal page 220. Upon visiting the statistical reports/journal page 220, subscriber level users are presented with a listing of available reports and/or journals on page 1102. The user may then select a particular report/journal and review it on page 1104. Providing this additional information in a user-friendly manner enables comprehensive Six Sigma research to be conducted at one location.

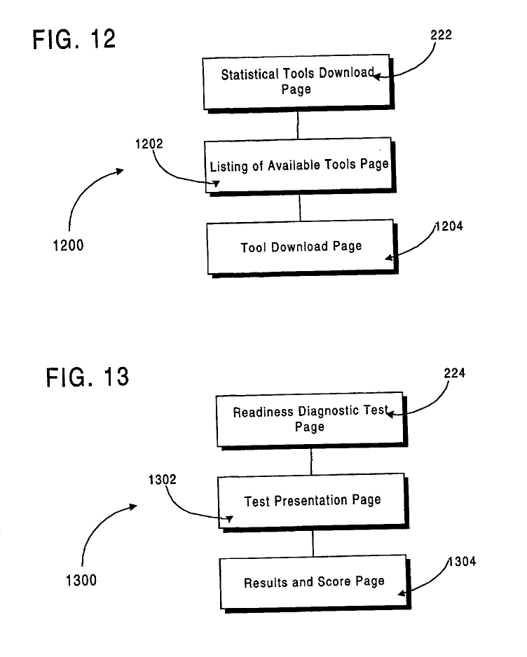

Similarly, the present invention provides for the availability of various statistical tools to assist users in achieving Six Sigma. Referring now to FIG. 12, there is shown a second level operational map 1200, illustrating the various options and web pages available under the statistical tools download page 222. A listing of downloadable tools is provided and described on page 1202. Once a particular tool has been selected by the user, page 1204 enables the user the download the tool from the site. In another embodiment, the requested tools may be e-mailed or otherwise transmitted to the participants rather than by direct download.

In order to enable users and their organizations to better analyze their current position and readiness for Six Sigma implementation, the system of the present invention provides a readiness diagnostic test. Referring now to FIG. 13, there is shown a second level operational map 1300, illustrating the various options and web pages available under the readiness diagnostic test page 224. Upon visiting the readiness diagnostic test page 224, the system of the present invention briefly describes the nature of the readiness diagnostic test and ascertaining an organization's ability to implement Six Sigma or other efficiency enhancement methodologies. If desired, users may visit a test presentation page 1302. The readiness diagnostic test preferably includes several questions related to the leadership/culture of the organization; the tools and methods of the organization; and the organization and physical infrastructure of the organization. The results of the test are then displayed to the user on page 1304 in any suitable fashion including descriptive charts, graphs, etc.

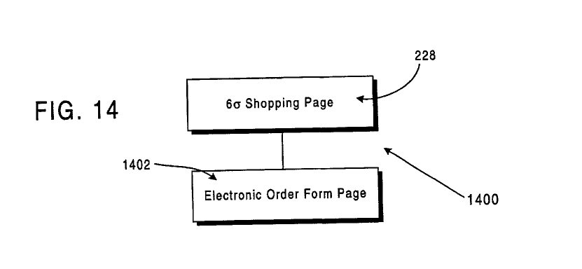

An additional feature offered in accordance with the present invention is included on the Six Sigma shopping page 226. Referring now to FIG. 14, there is shown a second level operational map 1400, illustrating the various options and web pages available under the Six Sigma shopping page 226. Upon visitation of the Six Sigma shopping page 226, the user is presented with brief descriptions of various Six Sigma related books, software, and published documents available for purchase on-line. The user may review the brief descriptions and select items for purchase. An electronic order form is provided on page 1402 for enabling users to purchase the materials on-line.

By providing a wide variety of Six Sigma consulting and informational services remotely at a common location, the system of the present invention enables organizations to more efficiently and effectively implement the Six Sigma methodology.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as intended to be encompassed by the following claims and their legal equivalents.

What is claimed is:

1. A method for providing six sigma consulting services over a computer network, comprising the steps of:
receiving, from a client computer associated with a user, a request to view at least one web page including six sigma-related content,
wherein the six-sigma related content includes at least general six sigma informational content for providing users with general information relating to the six sigma methodology, mentoring content for providing users with mentoring services relating to six sigma, and training content for providing users with information and services related to six sigma training; and
displaying said at least one web page to the client computer.

2. The method of claim 1 further comprising the steps of:
receiving a request to view a general six sigma information web page;
displaying said general six sigma information web page to the client computer;
said general six sigma information web page including a plurality of options related to different types of general six sigma information;
receiving a request to view a web page related to a selected one of the plurality of options; and
displaying said web page related to a selected one of the plurality of options to the client computer.

3. The method of claim 2, wherein the plurality of options related to different types of general six sigma information include at least the following: an overview/history option, a six sigma happenings option, a six sigma statistics option, and a six sigma glossary option.

4. The method of claim 1, further comprising the steps of:
receiving a request to view a mentoring services web page;
displaying said mentoring services web page to the client computer;
said mentoring services web page including a plurality of options related to different features of said mentoring services;
receiving a request to view a web page related to a selected one of the plurality of options; and
displaying said web page related to a selected one of the plurality of options to the client computer.

5. The method of claim 4, wherein said plurality of options related to different features of said mentoring services include at least the following: a process description option, a schedule session option, an attend session option, a management option, and a one on one question and answer session option.

6. The method of claim 1, further comprising the steps of:
receiving a request, from the client computer, to establish a mentoring/project review session;
displaying, to the client computer, a listing of available mentors/reviewers and a schedule of available session times;
receiving, from the client computer, a selection of one of the available mentors/reviewer and one of the available session times;
displaying, to the client computer, a preliminary session cost based upon the selected time and the selected mentor/reviewer;
receiving, from the client computer, a submitted session request; and
displaying, to the client computer, a session confirmation including at least session log-in information.

7.The method of claim 6, further comprising the steps of:
allocating resources to the session in the form of web space, and telecommunications resources;
notifying the selected mentor/reviewer of the confirmed session time;
receiving, from the client computer, project materials for review during the session;
notifying, at a predetermined interval prior to session commencement, each session participant reminding them of the session time and log-in information;
receiving log-in information from each of session participant;
establishing and maintaining any required communications means;
notifying the user of impending session end and inquiring as to an extension of the session;
determining whether an extension has been requested,
if an extension is requested, adjusting the session cost and maintaining the communication means;
if an extension is not request, concluding the session and recording a final session cost; and
transmitting a session receipt to the user indicating the final session cost and terms for payment.

8. The method of claim 7, wherein the step of notifying, at a predetermined interval prior to session commencement, each session participant reminding them of the session time and log-in information, further comprises the step of notifying each session participant by electronic mail.

9. The method of claim 7, wherein the step of notifying, at a predetermined interval prior to session commencement, each session participant reminding them of the session time and log-in information, further comprises the step of notifying each session participant by telephonic voice mail.

10. The method of claim 7, wherein the step of notifying, at a predetermined interval prior to session commencement, each session participant reminding them of the session time and log-in information, further comprises the step of notifying each session participant by pager.

11. The method of claim 1, further comprising the steps of:
receiving a request to view a training services web page;
displaying said training services web page to the client computer;
said training services web page including a plurality of options related to different features of said training services;
receiving a request to view a web page related to a selected one of the plurality of options; and
displaying said web page related to a selected one of the plurality of options to the client computer.

12. The method of claim 11, wherein said plurality of options related to different features of said training services include at least the following: a certification request option, and an on line training and seminar option process description option.

13. A computer readable medium including instructions for providing six sigma consulting services over a computer network, comprising:
one or more instructions for receiving, from a client computer associated with a user, a request to view at least one web page including six sigma-related content,
wherein the six-sigma related content includes at least general six sigma informational content for providing users with general information relating to the six sigma methodology, mentoring content for providing users with mentoring services relating to six sigma, and training content for providing users with information and services related to six sigma training; and
one or more instructions for displaying said at least one web page to the client computer.

14. The computer readable medium of claim 13 further comprising:
one or more instructions for receiving a request to view a general six sigma information web page;
one or more instructions for displaying said general six sigma information web page to the client computer;
said general six sigma information web page including a plurality of options related to different types of general six sigma information;
one or more instructions for receiving a request to view a web page related to a selected one of the plurality of options; and
one or more instructions for displaying said web page related to a selected one of the plurality of options to the client computer.

15. The computer readable medium of claim 14, wherein the plurality of options related to different types of general six sigma information include at least the following: an overview/history option, a six sigma happenings option, a six sigma statistics option, and a six sigma glossary option.

16. The computer readable medium of claim 13, further comprising:
one or more instructions for receiving a request to view a mentoring services web page;
one or more instructions for displaying said mentoring services web page to the client computer;
said mentoring services web page including a plurality of options related to different features of said mentoring services;
one or more instructions for receiving a request to view a web page related to a selected one of the plurality of options; and
one or more instructions for displaying said web page related to a selected one of the plurality of options to the client computer.

17. The computer readable medium of claim 16, wherein said plurality of options related to different features of said mentoring services include at least the following: a process description option, a schedule session option, an attend session option, a management option, and a one on one question and answer session option.

18. The computer readable medium of claim 15, further comprising:
one or more instructions for receiving a request, from the client computer, to establish a mentoring/project review session;
one or more instructions for displaying, to the client computer, a listing of available mentors/reviewers and a schedule of available session times;
one or more instructions for receiving, from the client computer, a selection of one of the available mentors/reviewer and one of the available session times;
one or more instructions for displaying, to the client computer, a preliminary session cost based upon the selected time and the selected mentor/reviewer;
one or more instructions for receiving, from the client computer, a submitted session request; and
one or more instructions for displaying, to the client computer, a session confirmation including at least session log-in information.

19. The computer readable medium of claim 18, further comprising:
one or more instructions for allocating resources to the session in the form of web space, and telecommunications resources;
one or more instructions for notifying the selected mentor/reviewer of the confirmed session time;
one or more instructions for receiving, from the client computer, project materials for review during the session;
one or more instructions for notifying, at a predetermined interval prior to session commencement, each session participant reminding them of the session time and log-in information;
one or more instructions for receiving log-in information from each of session participant;
one or more instructions for establishing and maintaining any required communications means;
one or more instructions for notifying the user of impending session end and inquiring as to an extension of the session;
one or more instructions for determining whether an extension has been requested,
if an extension is requested, one or more instructions for adjusting the session cost and maintaining the communication means;
if an extension is not request, one or more instructions for concluding the session and recording a final session cost; and
one or more instructions for transmitting a session receipt to the user indicating the final session cost and terms for payment.

20. The computer readable medium of claim 19, wherein the one or more instructions for notifying, at a predetermined interval prior to session commencement, each session participant reminding them of the session time and log-in information, further comprises the one or more instructions for notifying each session participant by electronic mail.

21. The computer readable medium of claim 19, wherein the one or more instructions for notifying, at a predetermined interval prior to session commencement, each session participant reminding them of the session time and log-in information, further comprises one or more instructions for notifying each session participant by telephonic voice mail.

22. The computer readable medium of claim 19, wherein the one or more instructions for notifying, at a predetermined interval prior to session commencement, each session participant reminding them of the session time and log-in information, further comprises one or more instructions for notifying each session participant by pager.

23. The computer readable medium of claim 13, further comprising:
one or more instructions for receiving a request to view a training services web page;
one or more instructions for displaying said training services web page to the client computer;
said training services web page including a plurality of options related to different features of said training services;
one or more instructions for receiving a request to view a web page related to a selected one of the plurality of options; and
one or more instructions for displaying said web page related to a selected one of the plurality of options to the client computer.

24. The computer readable medium of claim 23, wherein said plurality of options related to different features of said training services include at least the following: a certification request option, and an on-line training and seminar option process description option.

25. A system for providing six sigma consulting services over a computer network, comprising:
means for receiving, from a client computer associated with a user, a request to view at least one web page including six sigma-related content,
wherein the six-sigma related content includes at least general six sigma informational content for providing users with general information relating to the six sigma methodology, mentoring content for providing users with mentoring services relating to six sigma, and training content for providing users with information and services related to six sigma training; and
means for displaying said at least one web page to the client computer.

26. The system of claim 25 further comprising:
means for receiving a request to view a general six sigma information web page;
means for displaying said general six sigma information web page to the client computer;
said general six sigma information web page including a plurality of options related to different types of general six sigma information;
means for receiving a request to view a web page related to a selected one of the plurality of options; and
means for displaying said web page related to a selected one of the plurality of options to the client computer.

27. The system of claim 26, wherein the plurality of options related to different types of general six sigma information include at least the following: an overview/history option, a six sigma happenings option, a six sigma statistics option, and a six sigma glossary option.

28. The system of claim 25, further comprising:
means for receiving a request to view a mentoring services web page;
means for displaying said mentoring services web page to the client computer;
said mentoring services web page including a plurality of options related to different features of said mentoring services;
means for receiving a request to view a web page related to a selected one of the plurality of options; and
means for displaying said web page related to a selected one of the plurality of options to the client computer.

29. The system of claim 28, wherein said plurality of options related to different features of said mentoring services include at least the following: a process description option, a schedule session option, an attend session option, a management option, and a one on one question and answer session option.

30. The system of claim 25, further comprising:
means for receiving a request, from the client computer, to establish a mentoring/project review session;
means for displaying, to the client computer, a listing of available mentors/reviewers and a schedule of available session times;
means for receiving, from the client computer, a selection of one of the available mentors/reviewer and one of the available session times;
means for displaying, to the client computer, a preliminary session cost based upon the selected time and the selected mentor/reviewer;
means for receiving, from the client computer, a submitted session request; and
means for displaying, to the client computer, a session confirmation including at least session log-in information.

31. The system of claim 30, further comprising:
means for allocating resources to the session in the form of web space, and telecommunications resources;
means for notifying the selected mentor/reviewer of the confirmed session time;
means for receiving, from the client computer, project materials for review during the session;
means notifying, at a predetermined interval prior to session commencement, each session participant reminding them of the session time and log-in information;
means receiving log-in information from each of session participant;
means establishing and maintaining any required communications means;
means notifying the user of impending session end and inquiring as to an extension of the session;
means determining whether an extension has been requested,
if an extension is requested, means for adjusting the session cost and maintaining the communication means;
if an extension is not request, means for concluding the session and recording a final session cost; and
means for transmitting a session receipt to the user indicating the final session cost and terms for payment.

32. The system of claim 31, wherein the means for notifying, at a predetermined interval prior to session commencement, each session participant reminding them of the session time and log-in information, further comprise means for notifying each session participant by electronic mail.

33. The system of claim 31, wherein the means for notifying, at a predetermined interval prior to session commencement, each session participant reminding them of the session time and log-in information, further comprise means for notifying each session participant by telephonic voice mail.

34. The system of claim 31, wherein the means for notifying, at a predetermined interval prior to session commencement, each session participant reminding them of the session time and log-in information, further comprise means for notifying each session participant by pager.

35. The system of claim 25, further comprising:
means for receiving a request to view a training services web page;
means for displaying said training services web page to the client computer;
said training services web page including a plurality of options related to different features of said training services;
means for receiving a request to view a web page related to a selected one of the plurality of options; and
means for displaying said web page related to a selected one of the plurality of options to the client computer.

36. The system of claim 35, wherein said plurality of options related to different features of said training services include at least the following: a certification request option, and an online training and seminar option process description option.
